(19) United States
(12) Patent Application Publication
(10) Pub. No.: US 2015/0282039 A1
(43) Pub. Date: Oct. 1, 2015

(54) APPARATUS AND METHOD FOR TRANSFERRING DATA USING CONCURRENT TRANSMISSION

(71) Applicant: Electronics and Telecommunications Research Institute, Daejeon (KR)

(72) Inventors: Jong-Jun PARK, Daejeon (KR); Jeong-Gil KO, Daejeon (KR); Jong-Soo JEONG, Daejeon (KR); Jong-Arm JUN, Daejeon (KR)

(21) Appl. No.: 14/596,612

(22) Filed: Jan. 14, 2015

(30) Foreign Application Priority Data
Mar. 26, 2014 (KR) 10-2014-0035470

(51) Int. Cl. H04W 40/00; H04W 52/02; H04W 84/18; H04L 12/721; H04W 40/26

(52) U.S. Cl. CPC H04W 40/005; H04L 45/26; H04W 40/26; H04W 84/18; H04W 52/0235

(57) ABSTRACT

A method for transferring data in a method for transferring data signals by a data communication system comprising at least one node, the method comprises: transmitting a wakeup message when a source node receives a probe packet from at least one of other communication nodes; when at least one node which received the wakeup message is a relay node, transmitting the wakeup message upon receiving the probe packet from another communication node by the relay node; when the node which received the wakeup message is a destination node, transmitting a suppress message upon receiving the wakeup message by the destination node; when the relay node receives the suppress message, transmitting the suppress message; and when the source node receives the suppress message, transmitting concurrently a data signal to the destination node through the relay node.

### CROSS REFERENCE TO RELATED APPLICATION

This application claims the benefit of Korean Patent Application No. 10-2014-0035470, filed on Mar. 26, 2014, entitled “Apparatus and method for transferring data using concurrent transmission”, which is hereby incorporated by reference in its entirety into this application.

### BACKGROUND OF THE INVENTION

1. Technical Field

The present invention relates to data transmission and more particularly, data transmission using concurrent transmission at ad-hoc networks.

2. Description of the Related Art

There are a reactive routing such as Ad hoc On-Demand Distance Vector (AODV), which finds routes from a source node to a destination node through broadcast relay, and a proactive routing which forms network topology by broadcasting its presence periodically such as tree networks and transmits data signal based on the topology in a conventional ad-hoc routing. However, when data transmission is not much in low-power wireless networks, both routing methods not only cause more energy consumption to maintain routing tables but also increase network traffics which result in low communication efficiency of networks.

Particularly in wireless ad-hoc networks, which require energy efficiency, such as wireless sensor networks, duty-cycling, in which each node spends most of its time in the sleep mode and wakes up periodically for communication, is generally used. Conventional routing methods require broadcast to determine routing paths and update routing tables, but broadcast is inefficient communication requiring high energy consumption in duty-cycling-based networks. Accordingly, maintaining routing tables in low-power wireless networks is inefficient in terms of energy.

Recently, a concurrent transmission has been introduced in which more than two different nodes match time synchronization within the minimum time according to communication methods so that it does not cause interference between more than two packets and they can be received when two identical data signals are transmitted. For example, in case of 2.4 GHz OQPSK modulation of IEEE 802.15.4 standard, when more than two different nodes transmit identical data signals at the same time within ½ MHz=0.5 usec according to DSSS (Direct Sequence Spread Spectrum) chip rate, receiver nodes can receive the data signal reliably. All nodes should be in the wakeup mode to transmit data signals by using the concurrent transmission. Since local time of each node is different, all nodes perform time synchronization through concurrent transmission by waking up periodically in the conventional methods. However, it is still inefficient since all nodes requires high energy consumption for periodic communication in low-power wireless networks.

### SUMMARY OF THE INVENTION

An object of the present invention is to provide an apparatus for transferring data comprising a data communication system which does not use routing tables nor perform periodic time synchronization.

According to an aspect of the present invention, there is provided a method for transferring data in a method for transferring data signals by a data communication system comprising at least one node, the method comprising: transmitting a wakeup message when a source node receives a probe packet from at least one of other communication nodes; when at least one node which received the wakeup message is a relay node, transmitting the wakeup message by the relay node upon receiving the probe packet from the communication node; when the node which received the wakeup message is a destination node, transmitting a suppress message by the destination node upon receiving the wakeup message; when the relay node receives the suppress message, transmitting the suppress message; and when the source node receives the suppress message, transmitting concurrently a data signal to the destination node through the relay node.

The step of transmitting concurrently a data signal to the destination node through the relay node when the source node receives the suppress message may comprise: receiving the suppress message by the source node; transmitting the data signal by the source node; when the relay node receives the data signal, transmitting the data signal; and receiving the data signal by the destination node.

The step of transmitting concurrently a data signal to the destination node through the relay node when the source node receives the suppress message may further comprise waiting for transmission backoff time after the source node receives the suppress message.

The step of transmitting a suppress message by the destination node upon receiving the wakeup message may comprise: transmitting a suppress message when the destination node receives the wakeup message; and waiting for backoff time by the destination node.

The method for transferring data may further comprise converting to a sleep state by the relay node when data transmission is not performed during the relay node backoff time

The method for transferring data may further comprise transmitting data Ack to the source node through the relay node when the destination node completes the data transmission; and converting to a sleep state upon transmitting or receiving the data Ack by the source node, the relay node and the destination node.

According to another aspect of the present invention, there is provided an apparatus for transferring data comprising: a communication interface transmitting/receiving signals by being connected to at least one node; a processor performing data transmission according to an instruction through the communication interface; and a memory loading the instruction, wherein the instruction comprises instructions for: transmitting a wakeup message comprising an address of a destination node when a probe packet is received from at least one of first communication nodes after a transmission event occurs; receiving a suppress message from the first communication node; and transmitting a data signal according to the suppress message.

The step of receiving a suppress message from the first communication node may comprise: receiving a suppress message from the first communication node; and waiting for transmission backoff time.

The instruction may further comprise an instruction for converting to a sleep mode when message Ack is received from the first communication node.

The instruction may further comprise instructions for: transmitting a probe packet according to a pre-determined period before the transmission event occurs;

receiving the wakeup message from at least one of second communication nodes and converting to an wakeup mode according to the wakeup message; transmitting a suppress message when an address of a destination node included in the wakeup message is identical to an address of the apparatus; and receiving a data signal from the second communication node.

The step of transmitting a suppress message when an address of a destination node included in the wakeup message is identical to an address of the apparatus may comprise: waiting for backoff time after receiving the wakeup message; and transmitting a suppress message after the backoff time.

The instruction may further comprise an instruction for transmitting data Ack and converting to a sleep state when receiving the data signal from the second communication node is completed.

The instruction may further comprise instructions for: receiving a probe packet from at least one of third communication nodes when an address of a destination node included in the wakeup message is not identical to an address of the apparatus; transmitting the wakeup message upon receiving the probe packet from the third communication node; transmitting a suppress message when the suppress message is received from the third communication node; and transmitting a data signal when the data signal is received from the second communication node.

The instruction may further comprise an instruction for transmitting data Ack and converting to a sleep mode when the data Ack is received from the third communication node.

The instruction may further comprise an instruction for converting to a sleep state when data transmission is not performed during relay node backoff time.

The present invention as described above allows reduction in energy consumption by not using routing tables nor performing periodic time synchronization.

### BRIEF DESCRIPTION OF THE DRAWING

FIG. 1 illustrates an apparatus for transferring data according to an embodiment of the present invention.

FIG. 2 is a flowchart illustrating transmission of data signals by an apparatus for transferring data according to an embodiment of the present invention.

FIG. 3 is a block view illustrating a data communication system including a plurality of apparatuses for transferring data according to an embodiment of the present invention.

FIG. 4 is a flowchart illustrating transmission of data signals by a plurality of apparatuses for transferring data according to an embodiment of the present invention.

FIG. 5 illustrates transmission of data signals in a data communication system according to an embodiment of the present invention.

FIG. 6 illustrates another transmission of data signals in a data communication system according to an embodiment of the present invention.

FIG. 7 illustrates an embodiment of the present invention implemented in a computer system.

### DESCRIPTION OF THE EXEMPLARY EMBODIMENTS

While the present invention has been described with reference to particular embodiments, it is to be appreciated that various changes and modifications may be made by those skilled in the art without departing from the spirit and scope of the present invention, as defined by the appended claims and their equivalents.

When one element is described as being “transmit” or “signal transmission” from one element to another element, it shall be construed as being transmit or signal transmission to the other element directly but also as possibly having another element in between.

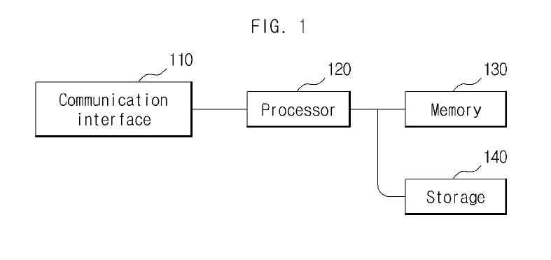

FIG. 1 illustrates an apparatus for transferring data according to an embodiment of the present invention.

Referring to FIG. 1, an apparatus for transferring data comprises a communication interface 110, a processor 120, a memory 130 and a storage 140.

The communication interface 110 transmits/receives one or more wireless signals by being connected to another communication node through a wireless communication protocol. For example, the communication interface 110 receives wireless signals such as probe packet, wakeup message, suppress message, data signal, data Ack and the like from another communication node. Here, the probe packet is a packet which each node sends periodically to another communication node in a known duty-cycling-based low power communication method. The suppress message is a message that a destination node, which is the final destination to receive data signals, informs that it is ready to receive data to a source node through a relay node. The data Ack is an Ack signal that the destination node informs that data reception is completed to the source node through the relay node. In addition, the communication interface 110 also transmits wireless signals such as probe packet, wakeup message, suppress message, data signal, data Ack and the like to another communication node. A data transmission process through each wireless signal will be explained in detail below.

The processor 120 performs data transmission according to instructions loaded in the memory 130. The memory 130 loads instructions for data transmission in the storage 140 and provides the loaded instructions to the processor 120.

The storage 140 stores instructions for data transmission.

Hereinafter, a process for transferring data signals depending on predetermined instructions by an apparatus for transferring data according to an embodiment of the present invention will be explained in detail.

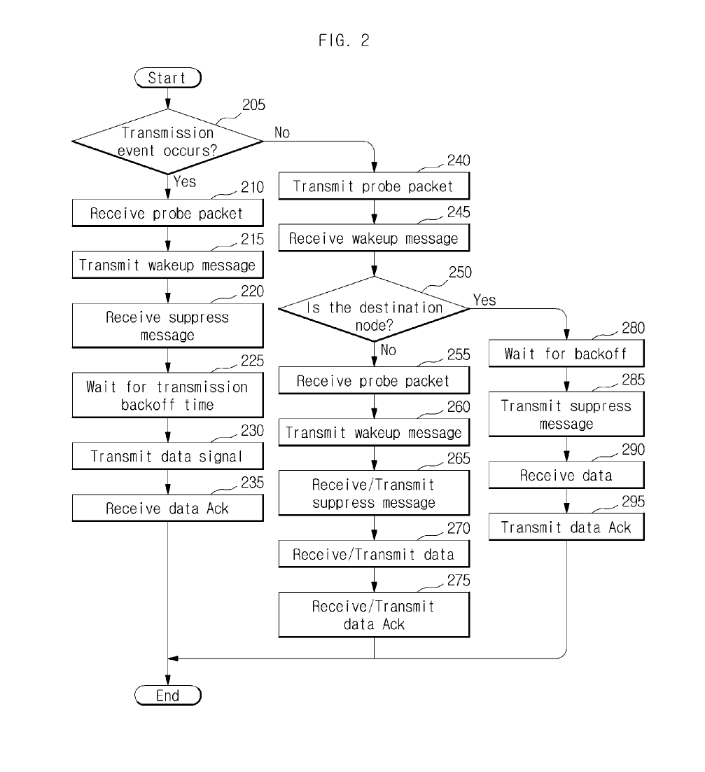

FIG. 2 is a flowchart illustrating transmission of data signals by an apparatus for transferring data according to an embodiment of the present invention. The apparatus for transferring data which will be described below may perform data transmission in conjunction with another communication node. Here, the apparatus for transferring data may carry a role among a source node which sends the first data signal; a destination node in which data will be transmitted finally; and a relay node which relays data transmission at between the source node and the destination node. When a process from S205 to S235 in FIG. 2 is performed, the apparatus for transferring data acts as a source node. When a process from S205 to S275 in FIG. 2 is performed, the apparatus for transferring data acts as a relay node. When a process from S205 to S295 in FIG. 2 is performed, the apparatus for transferring data acts as a destination node.

Each process including processes performed through each functional unit of an apparatus for transferring data will be explained hereinafter with an apparatus for transferring data as a general object for a concise and clear description of the present invention.

In addition, the apparatus for transferring data is able to reduce energy consumption by performing data communications in a wakeup mode or by transmitting probe signals and receiving wakeup signals after being converted into a sleep mode.

Each process for data communications by the apparatus for transferring data will be explained with reference to FIG. 2.

The apparatus for transferring data determines if a transmission event occurs in S205. The transmission event may be an event occurring when a data transmission is requested from an external device such as a terminal or an event which is already specified for data transmission such as an event occurring when a data transmission performs under presence of a certain data in the apparatus for transferring data. When a transmission event occurs in S205, the apparatus for transferring data stands by to receive a probe packet and receives the probe packet from another communication node during standing by in S210.

The apparatus for transferring data transmits a wakeup message in S215. The wakeup message may include an address of a destination node. Thus, the communication node which transmitted the probe packet in S210 may receive the corresponding wakeup message.

The apparatus for transferring data receives a suppress message transmitted from the destination node through one or more of relay nodes in S220. Here, the apparatus for transferring data may repeat the process from S215 when it does not receive the suppress message during backoff time.

Here, the backoff time is represented by the following Equation 1.

TO_{wakeup}=α×TO_{wakeup}+(1−α)×TO_{wakeupRep} Equation 1

Here, TO_{wakeup} is initialized as the maximum hop number of network (Hₘₐₓ)×time (I_{wakeup}) and, and a is a predetermined constant of a wait factor. TO_{wakeupRep} is determined by the following Equation 2.

TO_{wakeupRep}=H_{reported}×I_{wakeup} Equation 2

Here, H_{reported} is a number of hops from the apparatus for transferring data in a previous data transmission to the destination node when data signals are transmitted once or more previously. The number of hops is included in a suppress message and each apparatus for transferring data may increase H_{reported} one at a time when it transmits the suppress message to another communication node. Therefore, the apparatus for transferring data which is a source node may confirm H_{reported} with referring to the received suppress message for previous data transmission. I_{wakeup} is a transmission backoff time and is represented by the following Equation 3.

The apparatus for transferring data waits for transmission backoff time represented by the following Equation 3 in S225.

I_{wakeup}=2×(sink delay+packet transmission time) Equation 3

Here, the sink delay may be a predetermined constant and the packet transmission time may be time spent in the transmission of the suppress message from the destination node to the source node. Here, the destination node may include the transmission time of the suppress message into the suppress message and the apparatus for transferring data may calculate packet transmission time by using difference in time between the time when the suppress message is transmitted and the time when the suppress message is received.

The apparatus for transferring data transmits a data signal when the transmission backoff time is completed in S230. For example, when a suppress message is received from a first relay node and a suppress message is received from a second relay node during the backoff time, the apparatus for transferring data transmits the data signal to the first relay node and the second relay node so that both the first relay node and the second relay node are able to receive the data signal at the same time. The apparatus for transferring data transmits data signals after waiting for the transmission backoff time so that it is able to avoid collision between the suppress message which is being transmitted and the data signal which the apparatus for transferring data transmits.

The apparatus for transferring data receives data Ack from the communication node (relay node) and converts to a sleep mode upon receiving the adat Ack after the data transmission is completed in S235.

When any transmission event does not occur in S205, the apparatus for transferring data transmits a probe packet according to a pre-determined period in S240.

In S245, the apparatus for transferring data receives a wakeup message from another communication node which is received the probe packet transmitted in S240.

The apparatus for transferring data determines if its own address is the address of the destination node by comparing the address of the destination node included in the wakeup message with its own address in S250. That is, when its own address is identical to is the address of the destination node, the apparatus for transferring data determines that it is the destination node. On the other hand, when its own address is not identical to is the address of the destination node, the apparatus for transferring data determines that it is a relay node, not the destination node.

When it is determined that the apparatus for transferring data is not the destination node in S250, it receives a probe packet from another communication node in S255. That is, the apparatus for transferring data receives a probe packet as a relay node.

In S260, the apparatus for transferring data transmits the wakeup message received in S245 according to the probe packet received in S255. Thus, the communication node transmitted the probe packet in S255 receives the wakeup message and converts it to a wakeup mode.

In S265, the apparatus for transferring data receives a suppress message from another communication node and transmits the corresponding suppress message. Thus, other communication nodes which are located in the transmission area of the apparatus for transferring data may receive the suppress message. Then, even though the apparatus for transferring data receives the same suppress message from other communication nodes, it does not transmit the suppress message.

In S270, the apparatus for transferring data receives a data signal from at least one of other communication nodes and transmits the data signal. Here, when the apparatus for transferring data receives the same data signal from at least one of other communication nodes at the same time, it is able to receive each data signal without interference between data signals. The apparatus for transferring data thus receives data signals in a concurrent transmission.

In S275, the apparatus for transferring data receives data Ack from another communication node, transmits the data Ack, and converts to a sleep mode.

Therefore, the communication node located in the transmission area of the apparatus for transferring data is able to receive data Ack.

When it is determined that the apparatus for transferring data is the destination node in S250, it waits for backoff time in which the backoff time may be predetermined

In S285, after the backoff time, the apparatus for transferring data transmits a suppress message to another communication node. Thus, the apparatus for transferring data is able to avoid collision between wakeup messages which are being transmitted during the backoff time and suppress messages.

In S290, the apparatus for transferring data receives data signals from at least one of other communication nodes at the same time.

In S295, the apparatus for transferring data transmits data Ack to the at least one of other communication nodes which have transmitted the suppress message in S285 and converts to a sleep mode.

Here, the source node can increase success rate by performing clear channel assessment (CCA) during initial transmission of probe packets, wakeup messages, suppress messages and data. However, the relay node may not perform CCA for accurate time calculation and concurrent transmission. In addition, the apparatus for transferring data may transmit data signals concurrently by increasing transmission power by 5 dBm, compared to those of the probe packet and the wakeup message to have interference at a hidden terminal and thus transmit by capture effect.

Even though it is explained with reference to FIG. 2 that the apparatus for transferring data converts to a sleep mode upon transmitting or receiving data Ack, transmission of data Ack may be omitted depending on implementation method and it can convert into a sleep mode depending on each situation.

For example, in S235, the apparatus for transferring data may convert directly to a sleep mode after the data transmission is completed.

In S270, the apparatus for transferring data converts into a sleep mode and ends the data transmission process when any transmission of data signals is not performed during the relay node backoff time (TO_{TX}) after the suppress message is transmitted. The relay node backoff time is represented by the following Equation 4 or Equation 5.

$$\begin{matrix}{TO}_{{TX}_{h}} = ( {H}_{total} \cdot {C}_{TX} + {H}_{total} - h ) \cdot {T}_{SyncDelay} + {T}_{backoff} + ( {C}_{TX} - 1 ) \cdot {I}_{{C}_{TX}} + ɛ & Equation 4 \\ {TO}_{{TX}_{h}} = ( h \cdot {C}_{TX} ) \times {T}_{SyncDelay} + {T}_{backoff} + ( {C}_{TX} - 1 ) \cdot {I}_{{C}_{TX}} + ɛ & Equation 5\end{matrix}$$

C_{TX} is a number of data packets to deliver (data delivery may be several packets, not only one packet and when one packet is delivered, C_{TX} is 1), I is time to deliver packet(s), ands is a predetermined time (constant) for buffering. In addition, Hₜₒₜₐₗ is a number of hops between the source node and the destination node and h is a number of hops between the source node and the apparatus for transferring data. T_{backoff} may be a predetermined constant as backoff time. C_{TX} may be included in a header of each data packet and Hₜₒₜₐₗ and h may be included in the wakeup message.

In S295, the apparatus for transferring data converts to a sleep mode when data transmission is completed.

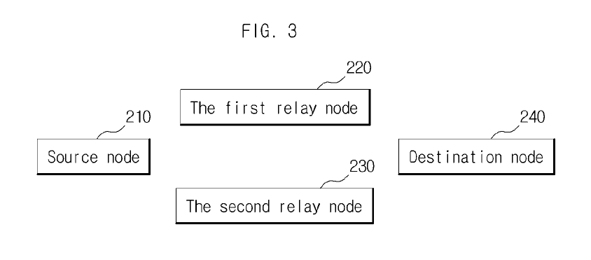

FIG. 3 is a block view illustrating a data communication system including a plurality of apparatuses for transferring data according to an embodiment of the present invention.

Referring to FIG. 3, a source node 210 is a node transmitting the first data signal in an apparatus for transferring data when transmission event occurs and transmits signals to or receives signals from a first relay node 220 and a second relay node 230 as described above with reference to FIG. 1 and FIG. 2. That is, the first relay node 220 and the second relay node 230 are located in the transmission area of the source node 210 in which the transmission area is the area capable of receiving signals transmitted from each node.

The first relay node 220 and the second relay node 230 are located between the source node 210 and the destination node 240, and the source node 210 and the destination node 240 are located in the transmission area of the first relay node 220 and the second relay node 23. Furthermore, the first relay node 220 and the second relay node 23 are located in the transmission area of the destination node 240.

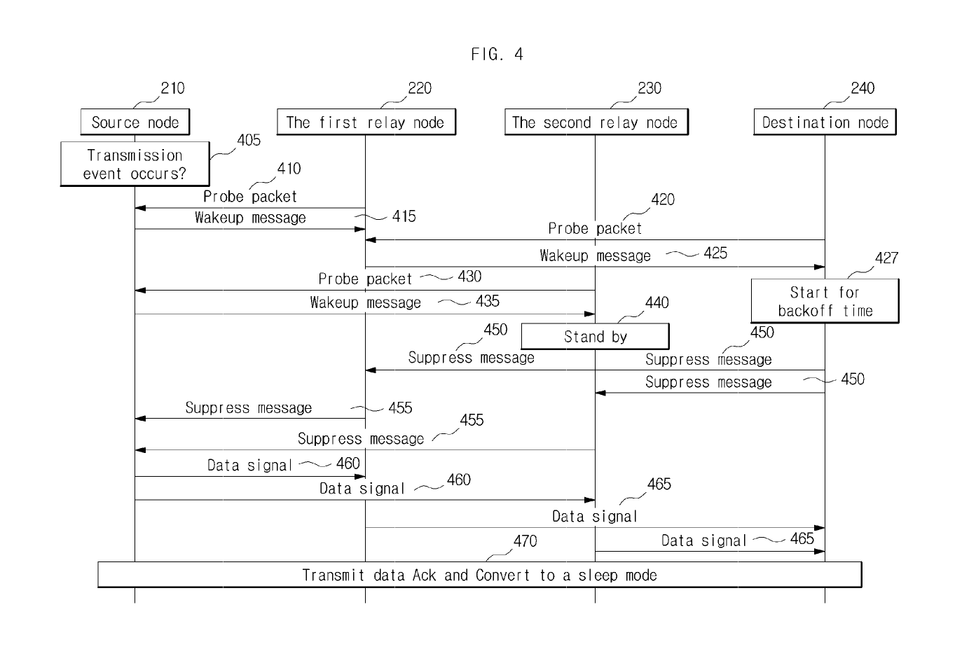

A process of data transmission of each node will be explained below with reference to FIG. 4.

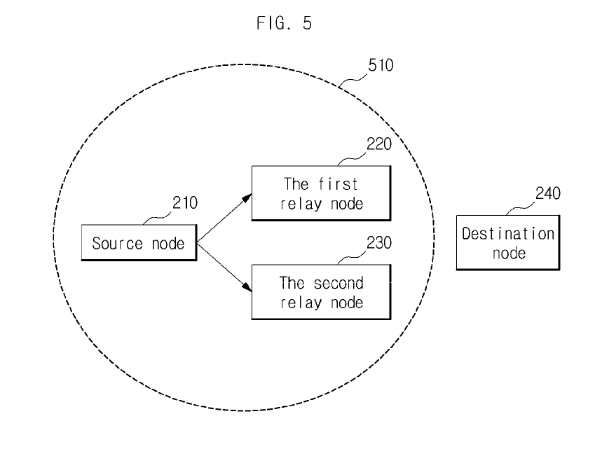

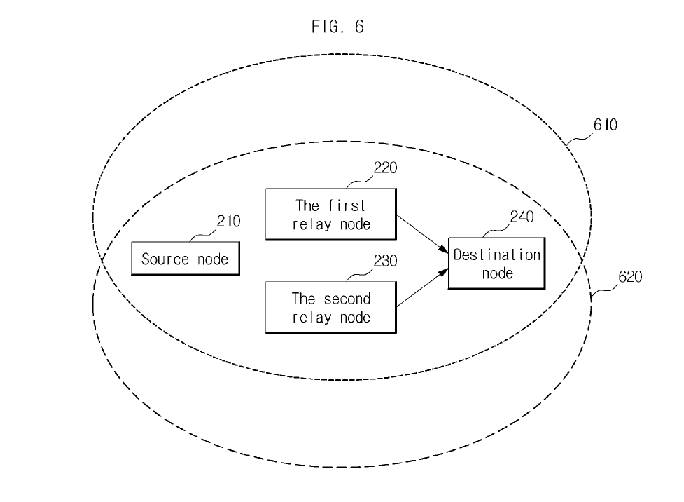

FIG. 4 is a flowchart illustrating transmission of data signals by a plurality of apparatuses for transferring data according to an embodiment of the present Invention. FIG. 5 illustrates transmission of data signals in a data communication system according to an embodiment of the present invention. FIG. 6 illustrates another transmission of data signals in a data communication system according to an embodiment of the present invention.

In S405, the source node 210 detects occurrence of a predetermined transmission event.

In S410, the source node 210 receives a probe packet from the first relay node 220.

In S415, the source node 210 transmits a wakeup message including an address of the destination node 240 and the first relay node 220 receives the wakeup message and converts to a wakeup mode. Here, the second relay node 220 does not receive the wakeup message since it does not transmit a probe packet.

In S420, the first relay node 220 determines if the first relay node 220 is a destination node using the address included in the wakeup message and then receives a probe packet from the destination node 240 while waiting.

In S425, the first relay node 220 transmits the wakeup message and the destination node 240 receives the wakeup message and converts to a wakeup mode.

In S427, the destination node 240 waits for backoff time. Here, it is assumed that the backoff time is the time from S427 to S445.

In S430, the source node 210 receives a probe packet from the second relay node 230.

In S435, the source node 210 transmits a wakeup message including an address of the destination node 240 and the second relay node 230 receives the wakeup message and converts to a wakeup mode.

In S440, the second relay node 230 determines if the second relay node 230 is a destination node using the address included in the wakeup message and then waits.

In S450, the destination node 240 transmits a suppress message to the first relay node 220 and the second relay node 230 during the backoff time. Thus, any collision between the wakeup message being transmitted in S435 and the suppress message can be avoided.

In S455, the first relay node 220 and the second relay node 230 transmit a suppress message concurrently upon receiving the suppress message from the destination node 240.

In S460, the source node 210 starts data transmission after waiting for transmission backoff time. Here, the first relay node 220 and the second relay node 230 can receive data signals transmitted from the source node 210 concurrently. For example, as shown in FIG. 5, the first relay node 220 and the second relay node 230 located in the transmission area 510 of the source node 210 can receive data signals concurrently when the source node 210 broadcasts the data signals.

In S465, the first relay node 220 and the second relay node 230 transmit the data signals concurrently when the data signals are received. Thus, the destination node 240 can receive the data signals from the first relay node 220 and the second relay node 230 concurrently. For example, as shown in FIG. 6, the destination node 240 located in the transmission area 610 of the first relay node 220 can receive the data signal transmitted from the first relay node 220 and concurrently, the destination node 240 located in the transmission area 620 of the second relay node 230 can also receive the data signal transmitted from the second relay node 230. Accordingly, concurrent transmission from the first relay node 220 and the second relay node 230 to the destination node 240 can be performed. Here, the source node 210 does not perform any separate operation since the data signal transmitted from the previous stage is received.

In S470, the destination node 240 transmits data Ack to the source node 210 through the first relay node 220 and the second relay node 230 concurrently. Here, the node which transmits or receives the data Ack converts to a sleep mode. Furthermore, S470 can be omitted according to implementation method, and each node of the source node 210 and the destination node 240 can be converted into a sleep mode, as described above by referring to FIG. 2, after data transmission is completed and the relay nodes 220, 230 can be converted to a sleep mode for the relay node backoff time when there is no data transmission.

In FIG. 4, the description is made with the relay nodes 220, 230 but it is apparent that the number of relay nodes increase when the distance between the source node 210 and the destination node 240 becomes longer.

The method for transferring data according to an embodiment of the present invention allows that each node transmits a wakeup message upon receiving a probe packet and converts to a wakeup mode to provide data signal transmission through a plurality of nodes with a specific path since data signals are transmitted or received when each node is in a wakeup mode, unlike the routing method which only transmits data to a particular node. The method for transferring data according to an embodiment of the present invention also allows all deliveries to other communication nodes because relay nodes transmit data signals so that it does not cause interference between data signals. The method for transferring data according to an embodiment of the present invention also allows that each node which receives data signals concurrently is able to receive the data signals with any interference because a plurality of nodes depending on the number of hops transmits data signals at the same time from the source node 210. Therefore, the method for transferring data according to an embodiment of the present invention provides data transmission without using routing tables nor interference so that it further reduces energy consumption which is used to generate routing tables and network resources.

In addition, the method for transferring data according to an embodiment of the present invention also reduces resource consumption associated with time synchronization because it allows concurrent transmissions without additional time synchronizations.

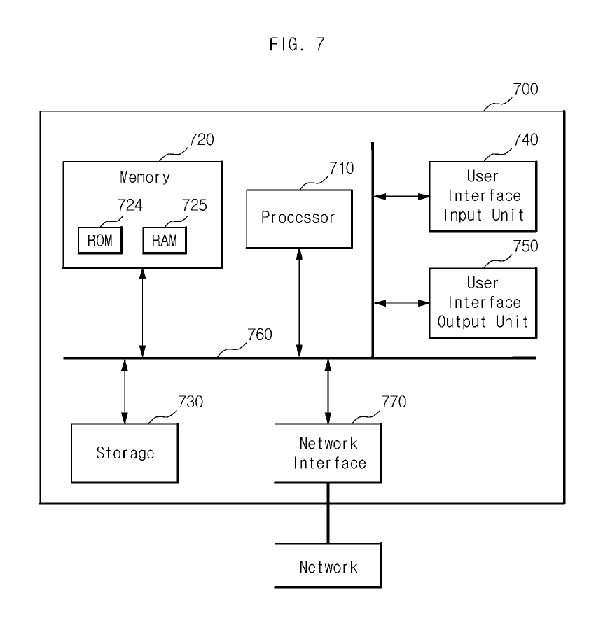

An embodiment of the present invention may be implemented in a computer system, e.g., as a computer readable medium. As shown in FIG. 7, a computer system 720-1 may include one or more of a processor 721, a memory 723, a user input device 726, a user output device 727, and a storage 728, each of which communicates through a bus 722. The computer system 720-1 may also include a network interface 729 that is coupled to a network 130. The processor 721 may be a central processing unit (CPU) or a semiconductor device that executes processing instructions stored in the memory 723 and/or the storage 728. The memory 723 and the storage 728 may include various forms of volatile or non-volatile storage media. For example, the memory may include a read-only memory (ROM) 724 and a random access memory (RAM) 725.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

While it has been described with reference to particular embodiments, it is to be appreciated that various changes and modifications may be made by those skilled in the art without departing from the spirit and scope of the embodiment herein, as defined by the appended claims and their equivalents. Accordingly, examples described herein are only for explanation and there is no intention to limit the invention. The scope of the present invention should be interpreted by the following claims and it should be interpreted that all spirits equivalent to the following claims fall with the scope of the present invention.

What is claimed is:

1. A method for transferring data in a method for transferring data signals by a data communication system comprising at least one node, the method comprising:
transmitting a wakeup message when a source node receives a probe packet from at least one of other communication nodes;
when at least one node which received the wakeup message is a relay node, transmitting the wakeup message by the relay node upon receiving the probe packet from another communication node;
when the node which received the wakeup message is a destination node, transmitting a suppress message by the destination node upon receiving the wakeup message;
when the relay node receives the suppress message, transmitting the suppress message; and
when the source node receives the suppress message, transmitting concurrently a data signal to the destination node through the relay node.

2. The method for transferring data of claim 1, wherein the step of transmitting concurrently a data signal to the destination node through the relay node when the source node receives the suppress message comprises:
receiving the suppress message by the source node;
transmitting the data signal by the source node,
when the relay node receives the data signal, transmitting the data signal; and
receiving the data signal by the destination node.

3. The method for transferring data of claim 2, wherein the step of transmitting concurrently a data signal to the destination node through the relay node when the source node receives the suppress message further comprises waiting for transmission backoff time after the source node receives the suppress message.

4. The method for transferring data of claim 1, wherein the step of transmitting a suppress message by the destination node upon receiving the wakeup message comprises:
transmitting a suppress message when the destination node receives the wakeup message; and
waiting for backoff time by the destination node.

5. The method for transferring data of claim 1, further comprising converting to a sleep state by the relay node when data transmission is not performed during the relay node backoff time.

6. The method for transferring data of claim 1, further comprising transmitting data Ack to the source node through the relay node when the destination node completes the data transmission; and
converting to a sleep state upon transmitting or receiving the data Ack by the source node, the relay node and the destination node.

7. An apparatus for transferring data comprising:
a communication interface transmitting/receiving signals by being connected to at least one node;
a processor performing data transmission according to an instruction through the communication interface; and
a memory loading the instruction,
wherein the instruction comprises instructions for:
transmitting a wakeup message comprising an address of a destination node when a probe packet is received from at least one of first communication nodes after a transmission event occurs;
receiving a suppress message from the first communication node; and
transmitting a data signal according to the suppress message.

8. The apparatus for transferring data of claim 7, wherein the step of receiving a suppress message from the first communication node comprises:
receiving a suppress message from the first communication node; and
waiting for transmission backoff time.

9. The apparatus for transferring data of claim 7, wherein the instruction further comprises an instruction for converting to a sleep mode when message Ack is received from the first communication node.

10. The apparatus for transferring data of claim 7, wherein the instruction further comprises instructions for:
transmitting a probe packet according to a pre-determined period before the transmission event occurs;
receiving the wakeup message from at least one of second communication nodes and converting to an wakeup mode according to the wakeup message;
transmitting a suppress message when an address of a destination node included in the wakeup message is identical to an address of the apparatus; and
receiving a data signal from the second communication node.

11. The apparatus for transferring data of claim 10, wherein the step of transmitting a suppress message when an address of a destination node included in the wakeup message is identical to an address of the apparatus comprises:
waiting for backoff time after receiving the wakeup message; and
transmitting a suppress message after the backoff time.

12. The apparatus for transferring data of claim 10, wherein the instruction further comprises an instruction for transmitting data Ack and converting to a sleep state when receiving the data signal from the second communication node is completed.

13. The apparatus for transferring data of claim 10, wherein the instruction further comprises instructions for:
receiving a probe packet from at least one of third communication nodes when an address of a destination node included in the wakeup message is not identical to an address of the apparatus;
transmitting the wakeup message upon receiving the probe packet from the third communication node;
transmitting a suppress message when the suppress message is received from the third communication node; and
transmitting a data signal when the data signal is received from the second communication node.

14. The apparatus for transferring data of claim 13, wherein the instruction further comprises an instruction for transmitting data Ack and converting to a sleep mode when the data Ack is received from the third communication node.

15. The apparatus for transferring data of claim 13, wherein the instruction further comprises an instruction for converting to a sleep state when data transmission is not performed during relay node backoff time.
